(19) United States
(12) Patent Application Publication
(10) Pub. No.: US 2015/0091476 A1
(43) Pub. Date: Apr. 2, 2015

(54) DEVICE FOR DRIVING PIEZO-ACTUATOR AND DRIVING METHOD THEREFOR

(71) Applicant: SNA CO., LTD., Yongin-si (KR)

(72) Inventors: Kyoungsoo Kwon, Yongin-si (KR); Chaedong Go, Hwaseong-si (KR); Hyunwoo Do, Gwangju-si (KR)

(21) Appl. No.: 14/381,297

(22) PCT Filed: Mar. 11, 2013
(86) PCT No.: PCT/KR2013/001933

§ 371 Date: Aug. 27, 2014

(30) Foreign Application Priority Data
Mar. 22, 2012 (KR) 10-2012-0029182

(51) Int. Cl. H02N 2/00

(52) U.S. Cl. CPC H02N 2/0075
USPC 318/116

(57) ABSTRACT

A device for driving a piezo-actuator comprises: a signal generating unit for generating signals having a constant frequency; and a modulation unit for modulating the signals generated from the signal generating unit and outputting the modulated signals, wherein the modulation unit comprises a density modulation unit which performs a first mode for repeating an operation for outputting an input signal at a first constant number and an operation for blocking the input signal at a second constant number, and which performs a second mode for repeating an operation for outputting the input signal during a first period and an operation for blocking the input signal during a second period. The device for driving the piezo-actuator and the method therefor can reduce the noise generated when the piezo-actuator for an automatic focus function of a camera is driven.

### BACKGROUND OF THE INVENTION

1. Field of the Invention

The present invention relates, in general, to a device and method for driving a piezoelectric actuator and, more particularly, to a device and method for driving a piezoelectric actuator for a camera module, which perform an auto-focus function for the camera module.

2. Description of the Prior Art

As expectations of the functions of cameras for mobile phones have become higher and have become more emphasized, the importance of additional functions of the cameras has increased. In order to realize an auto-focus (AF) function that is currently commercialized among such additional functions, the location of a lens must be moved, and an actuator is used to move the location of the lens.

Representative types of such actuators are a Voice Coiled Actuator (VCA) and a piezoelectric actuator. However, in an auto-focus function for video capturing, the use of a VCA is problematic in that excessive current consumption occurs, and the use of a piezoelectric actuator is problematic in that noise is recorded.

In order to solve the above-described noise problem or the like, a driving method for modulating the duty ratio of a pulse into a voltage required to drive the piezoelectric actuator or modulating the frequency of the pulse has been proposed, but at present such a solution has not yet reduced noise to a satisfactory level.

### SUMMARY OF THE INVENTION

The present invention is intended to solve the above-described technical problems, and an object of the present invention is to provide a device and method for driving a piezoelectric actuator, which can reduce noise occurring when a piezoelectric actuator for the auto-focus function of a camera is driven.

A device for driving a piezoelectric actuator according to a preferred embodiment of the present invention includes a signal generation unit for generating a signal having a certain frequency; and a modulation unit for modulating and outputting the signal generated by the signal generation unit.

More specifically, the modulation unit may include a density modulation unit for executing a first mode in which an operation of outputting as many input signals as a first predetermined number and an operation of blocking as many input signals as a second predetermined number are repeated, or a second mode in which an operation of outputting input signals for a first interval and an operation of blocking the input signals for a second interval are repeated.

The first mode according to a preferred embodiment may be configured to count as many input signals of the density modulation unit as the first predetermined number and as the second predetermined number, output as many input signals as the first predetermined number, and block as many input signals as the second predetermined number. Further, the second mode may be configured to filter and output the input signals of the density modulation unit using a filter signal in which a high signal is output for the first interval and a low signal is output for the second interval.

The modulation unit according to a preferred embodiment of the present invention may further include one or more of a frequency modulation unit for modulating a frequency of each input signal and outputting a modulated signal; a duty ratio modulation unit for modulating a duty ratio of the input signal and outputting a modulated signal; and an amplitude modulation unit for modulating an amplitude of the input signal using a constant envelope waveform and outputting a modulated signal.

The frequency modulation unit of the present invention may include a frequency setting module for setting a modulation frequency; and a frequency modulation module for modulating the frequency of the input signal of the frequency modulation unit depending on the modulation frequency and outputting the modulated signal. More specifically, the frequency setting module may be configured to set the modulation frequency while gradually changing the modulation frequency from a preset maximum frequency to a preset minimum frequency or from the minimum frequency to the maximum frequency.

The duty ratio modulation unit according to a preferred embodiment may include a duty ratio setting module for setting a duty ratio; and a duty ratio modulation module for modulating the duty ratio of the input signal of the duty ratio modulation unit depending on the duty ratio set by the duty ratio setting module, and outputting the modulated signal. More specifically, the duty ratio setting module may be configured to set the duty ratio while gradually changing the duty ratio from a preset maximum duty ratio to a preset minimum duty ratio or from the minimum duty ratio to the maximum duty ratio.

Further, the amplitude modulation unit may include an envelope generation module for generating a constant envelope waveform; and an amplitude modulation module for modulating the amplitude of the input signal of the amplitude modulation unit depending on the envelope waveform generated by the envelope generation module, and outputting the modulated signal. More specifically, the amplitude modulation module may modulate the amplitude of the input signal of the amplitude modulation unit by mixing the input signal of the amplitude modulation unit with the envelope waveform.

A method for driving a piezoelectric actuator according to a preferred embodiment of the present invention includes executing a first mode in which an operation of outputting as many input signals as a first predetermined number and an operation of blocking as many input signals as a second predetermined number are repeated, or a second mode in which an operation of outputting input signals for a first interval and an operation of blocking the input signals for a second interval are repeated.

Further, the method for driving the piezoelectric actuator may further include one or more of modulating a frequency of each input signal and outputting a modulated signal; modulating a duty ratio of the input signal and outputting a modulated signal; and modulating an amplitude of the input signal using a constant envelope waveform and outputting a modulated signal.

More specifically, modulating the frequency may be configured to set the modulation frequency while gradually changing the modulation frequency from a preset maximum frequency to a preset minimum frequency or from the minimum frequency to the maximum frequency, and to modulate the frequency of the input signal depending on the set modulation frequency.

Further, modulating the duty ratio may be configured to set the duty ratio while gradually changing the duty ratio from a preset maximum duty ratio to a preset minimum duty ratio or from the minimum duty ratio to the maximum duty ratio, and to modulate the duty ratio of the input signal depending on the set duty ratio.

Modulating the amplitude according to a preferred embodiment may be configured to generate a constant envelope waveform and to modulate the amplitude of the input signal depending on the generated envelope waveform.

In accordance with the device and method for driving a piezoelectric actuator according to preferred embodiments of the present invention, noise occurring when a piezoelectric actuator for the auto-focus function of a camera is driven can be reduced.

### BRIEF DESCRIPTION OF THE DRAWINGS

FIG. 1 is a diagram describing the principle of a Smooth Impact Drive Mechanism (SIDM) using the characteristics of a piezoelectric element;

FIG. 2 is a diagram illustrating a waveform of a drive signal for a piezoelectric element;

FIG. 3 is a configuration diagram showing a device for driving a piezoelectric actuator according to a preferred embodiment of the present invention;

FIG. 4A is a diagram illustrating input/output waveforms of a density modulation unit in a first mode;

FIG. 4B is a diagram illustrating input/output waveforms of a density modulation unit in a second mode;

FIG. 5A is a diagram illustrating an output waveform of a frequency modulation unit;

FIG. 5B is a diagram illustrating an output waveform of a duty ratio modulation unit; and

FIG. 5C is a diagram illustrating input and output waveforms of an amplitude modulation unit.

### DETAILED DESCRIPTION OF THE EXEMPLARY EMBODIMENTS

A device and method for driving a piezoelectric actuator according to embodiments of the present invention will be described in detail with reference to the attached drawings.

It is apparent that the following embodiments are merely intended to embody the present invention and are not intended to limit or restrict the scope of the present invention. Details that can be easily inferred by those skilled in the art to which the present invention pertains, from the detailed description and the embodiments of the present invention, should be interpreted as being included in the scope of the present invention.

The present invention presents technology relating to a method for effectively driving a piezoelectric element using a Smooth Impact Drive Mechanism (SIDM) method, among methods for driving an actuator that uses piezoelectric effect, in order to implement auto-focus of a camera module. For reference, a piezoelectric element is an element that is differently contracted and expanded according to the voltage at both ends of the piezoelectric element.

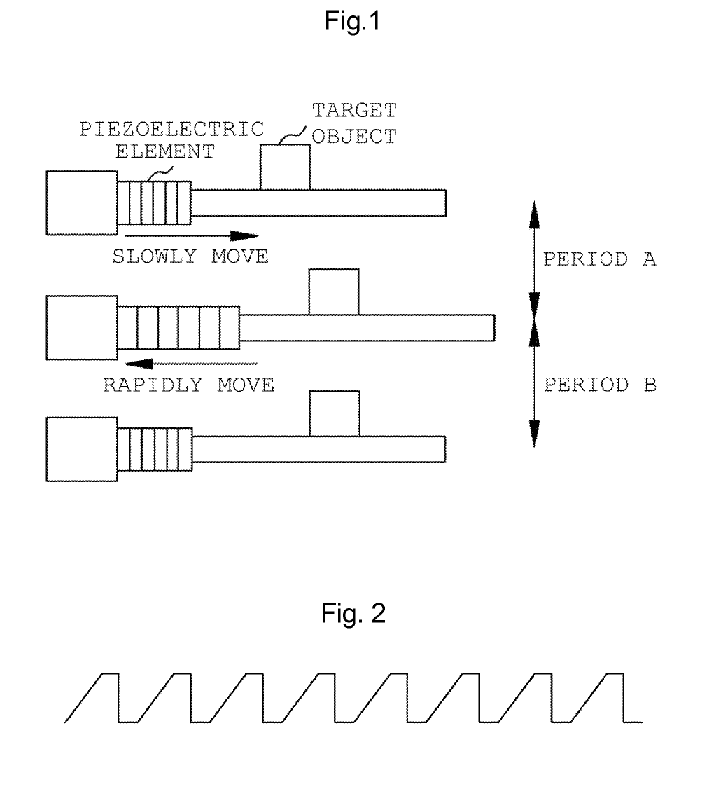

A diagram describing the principle of SIDM using the characteristics of the piezoelectric element and a diagram illustrating a waveform of a conventional drive signal for the piezoelectric element are respectively shown in FIGS. 1 and 2.

When a drive voltage in the drive signal waveform of FIG. 2 gently rises, the piezoelectric element is slowly expanded, as shown in period A of FIG. 1. Thereafter, when the voltage sharply falls down, the piezoelectric element is rapidly contracted, as shown in period B of FIG. 1. In this case, a frictional force between a target object and a moving object is decreased due to the rapid contraction of the piezoelectric element, and thus the target object seems to stop at its current location, but is consequently moved. Here, noise occurs at points in time at which the target object is initially driven and is stopped, thus causes the user to experience inconvenience. Therefore, a problem arises in that an auto-focus function cannot be applied to videos.

In order to solve such a noise problem, various attempts to precisely control the lens and realize noise reduction effects have been made in such a way as to drive the piezoelectric element in a deceleration mode at the start point of movement of the lens and at a point adjacent to a target location and to drive the piezoelectric element in an acceleration mode for a normal interval, by changing the duty ratio of a pulse in a drive waveform required to drive the piezoelectric element, but measures for better noise reduction are still required.

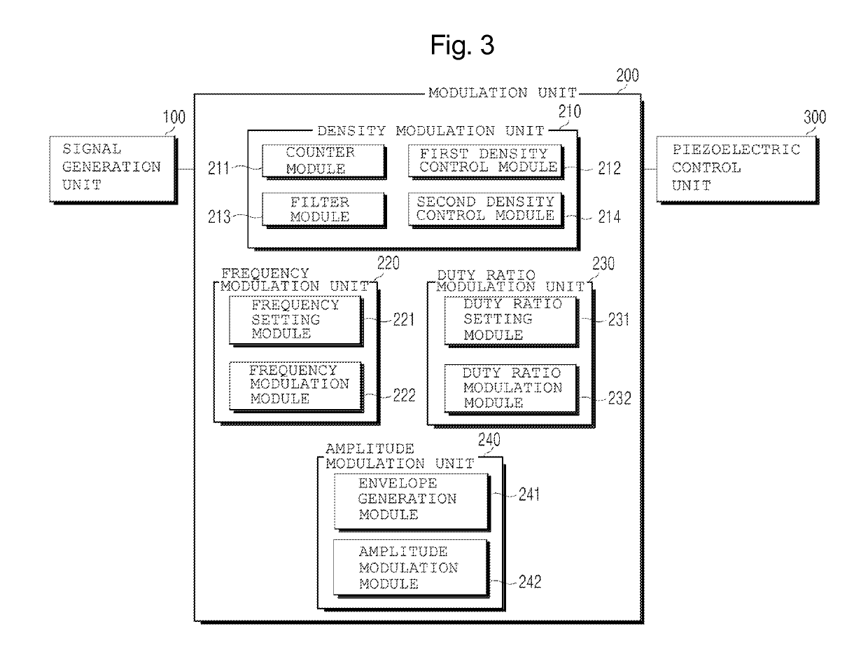

FIG. 3 is a configuration diagram showing a device for driving a piezoelectric actuator according to a preferred embodiment of the present invention. As can be seen in FIG. 3, the piezoelectric actuator driving device according to the preferred embodiment of the present invention includes a signal generation unit 100 for generating a signal having a certain frequency for driving a piezoelectric element, a modulation unit 200 for modulating and outputting the signal generated by the signal generation unit 100, and a piezoelectric control unit 300 for driving the piezoelectric element by applying a drive voltage to the piezoelectric element using the modulated signal from the modulation unit 200.

As the output of the signal generation unit 100 of the present invention, a repetitive pulse-shaped waveform such as that shown in FIG. 2 may be exemplified. However, the signal generation unit 100 of the present invention merely needs to repetitively output a signal having a certain frequency, and the output waveform is not necessarily limited to the shape of the waveform such as that shown in FIG. 2. An embodiment of the signal generation unit 100 of the present invention may be implemented to include an oscillator and a frequency divider. For description of the present invention, various types of repetitive signals from the signal generation unit 100 are referred to as “pulse signals.”

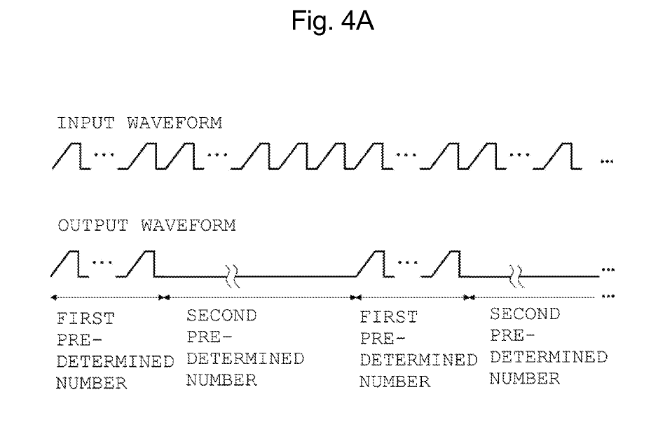

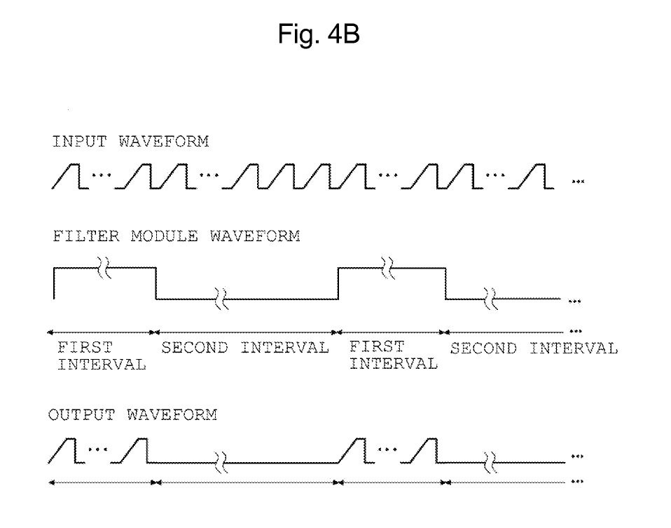

The present invention is intended to propose methods for implementing four types of Smooth Impact Drive Mechanisms (SIDMs). That is, a Pulse Density Modulation (PDM) method, a Frequency Modulation (FM) method, a Duty Ratio Modulation (DRM) method, and an Amplitude Modulation (AM) method correspond to the types. As can be seen in FIG. 4, the present invention includes a density modulation unit 210, a frequency modulation unit 220, a duty ratio modulation unit 230, and an amplitude modulation unit 240 to implement the four types of SIDMs. However, since reduction of noise that is purposed may be performed by combining a pulse density modulation method with one or more other modulation methods, a predetermined purpose may be achieved if one or more of the frequency modulation unit 220, the duty ratio modulation unit 230, and the amplitude modulation unit 240 are included.

First, a pulse density modulation method which is a preferred embodiment of the present invention will be described below.

Pulse density modulation, which is a scheme for controlling the pulse density of each input pulse signal, denotes a scheme implemented by controlling an interval during which a pulse at the resonant frequency that is output to drive the piezoelectric actuator is generated, and an interval during which the pulse at the resonant frequency is not generated, that is, an interval during which the pulse is blocked.

The present invention is intended to propose two types of methods for pulse density modulation performed by the density modulation unit 210. One may be implemented in a first mode in which input signals are counted and only as many input signals as a first predetermined number are output, and the other may be implemented in a second mode in which input signals are output only for a first interval.

In the first mode, the density modulation unit 210 may modulate pulse density by repeating an operation of outputting as many input signals as the first predetermined number from signals input to the density modulation unit 210 and an operation of blocking as many input signals as a second predetermined number from the input signals. In the second mode, the density modulation unit 210 also performs modulation of pulse density by repeating an operation of outputting input signals for the first interval and an operation of not outputting, that is, blocking, input signals for a second interval. For reference, the first interval and the second interval in the present invention mean predetermined time intervals.

For the first mode, the density modulation unit 210 preferably includes a counter module 211 for counting as many input signals as the first predetermined number and as the second predetermined number, and a first density control module 212 for outputting as many input signals as the first predetermined number and blocking as many input signals as the second predetermined number. Here, an example of counting of input signals means that the number of pulses is counted in the case of a pulse wave such as that shown in FIG. 2. Further, it can be seen that, in the case of a waveform in which a half cycle shape of a sine wave is repeated, counting of input signals means that pulses corresponding to the half cycle of the sine wave are counted.

Furthermore, for the second mode, the density modulation unit 210 preferably includes a filter module 213 for outputting a high signal for the first interval and outputting a low signal for the second interval, and a second density control module 214 for outputting input signals filtered by the filter module 213.

Examples of input/output waveforms of the density modulation unit 210 in the first mode and input/output waveforms of the density modulation unit 210 in the second mode are illustrated in FIGS. 4A and 4B.

In summary, in the first mode, when signals are input, the modulation of pulse density is performed by counting as many signals as the first predetermined number desired to be output and as many signals as the second predetermined number desired to be blocked. Further, in the second mode, when signals are input, the modulation of pulse density is performed by filtering input signals so that the input signals are output only for the first interval, depending on the setting of the first interval desired to be output and the second interval desired to be blocked.

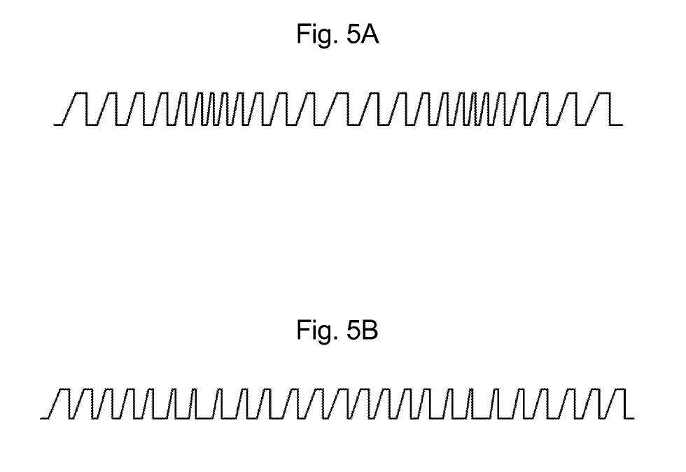

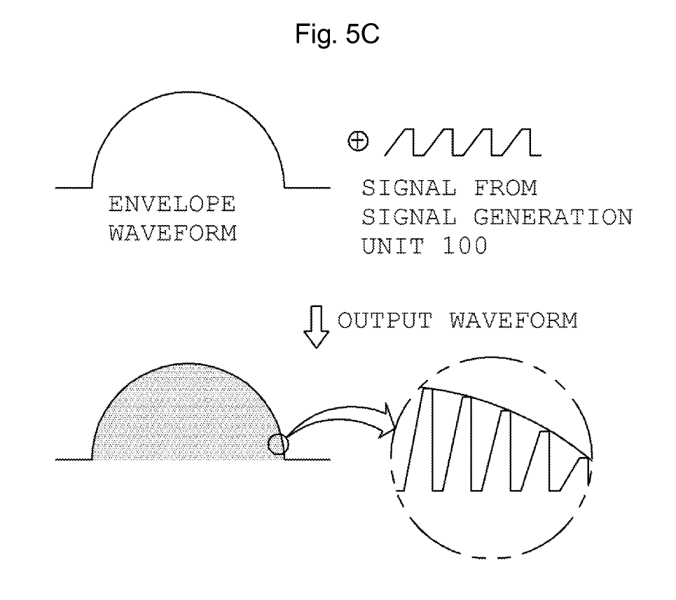

FIGS. 5A, 5B and 5C are diagrams illustrating output waveforms of the frequency modulation unit 220, the duty ratio modulation unit 230, and the amplitude modulation unit 240 when the input signal of FIG. 2 is assumed. The frequency modulation unit 220, the duty ratio modulation unit 230 and the amplitude modulation unit 240 according to the present invention will be described in detail below with reference to FIGS. 5A, 5B and 5C.

First, the frequency modulation unit 220 functions to modulate the frequency of each input signal and output a modulated signal.

The frequency modulation unit 220 according to a preferred embodiment includes a frequency setting module 221 for setting a modulation frequency and a frequency modulation module 222 for modulating the frequency of the signal input to the frequency modulation unit 220 depending on the modulation frequency set by the frequency setting module 221, and outputting a modulated signal.

Preferably, the frequency setting module 221 according to the present invention sets the modulation frequency while gradually, that is, slowly, changing the modulation frequency from a preset maximum frequency to a preset minimum frequency, or from the minimum frequency to the maximum frequency. By means of such a gradual change in the modulation frequency, the driving of the piezoelectric element is gently performed.

Next, the duty ratio modulation unit 230 functions to modulate the duty ratio of the input signal and output a modulated signal. The duty ratio modulation unit 230 according to a preferred embodiment is characterized in that it includes a duty ratio setting module 231 for setting a duty ratio, and a duty ratio modulation module 232 for modulating the duty ratio of the input signal of the duty ratio modulation unit 230 depending on the duty ratio set by the duty ratio setting module 231 and outputting a modulated signal. More specifically, the duty ratio setting module 231 is characterized in that it sets the duty ratio while gradually changing the duty ratio from a preset maximum duty ratio to a preset minimum duty ratio or from the minimum duty ratio to the maximum duty ratio.

Next, the amplitude modulation unit 240 functions to modulate the amplitude of the signal input to the amplitude modulation unit 240 using a constant envelope waveform, and output a modulated signal. Although a waveform similar to the half cycle of a sine wave is exemplified as the envelope waveform in FIG. 5C, it is apparent that amplitude modulation may be performed using various envelope waveforms in which the magnitude of voltage is gradually increased and then gradually decreased, for example, a trapezoidal waveform or the like. The amplitude modulation unit 240 preferably includes an envelope generation module 241 for generating a constant envelope waveform, and an amplitude modulation module 242 for modulating the amplitude of the input signal of the amplitude modulation unit 240 depending on the generated envelope waveform, and outputting a modulated signal. More specifically, the amplitude modulation module 242 is characterized in that the amplitude of the input signal of the amplitude modulation unit 240 is modulated by mixing the input signal of the amplitude modulation unit 240 with the envelope waveform.

Below, the sequence of modulation performed by the individual units 210, 220, 230, and 240 of the modulation unit 200 according to a preferred embodiment of the present invention will be described. For example, if it is assumed that modulation is performed by the density modulation unit 210 and the duty ratio modulation unit 230, the signal from the signal generation unit 100 may be modulated by the density modulation unit 210, and then the duty ratio of the output signal from the density modulation unit 210 may be modulated by the duty ratio modulation unit 230. Conversely, the duty ratio of the signal from the signal generation unit 100 may be modulated by the duty ratio modulation unit 230, and then the output signal from the duty ratio modulation unit 230 may be modulated by the density modulation unit 210.

Further, if it is assumed that modulation is performed by the density modulation unit 210 and the amplitude modulation unit 240, the signal from the signal generation unit 100 may be modulated by the density modulation unit 210, and the amplitude of the output signal from the density modulation unit 210 may be modulated by the amplitude modulation unit 240. Conversely, it is also possible that the amplitude of the signal from the signal generation unit 100 may be modulated by the amplitude modulation unit 240, and then the density of the output signal from the amplitude modulation unit 240 may be modulated by the density modulation unit 210.

Furthermore, it is apparent that, even in the case of modulation by the density modulation unit 210 and the frequency modulation unit 220, the sequence of modulation may be changed. It is also apparent that, even in the case of modulation performed by a combination of three or more types of units, the sequence of modulation may also be changed.

A method for driving a piezoelectric actuator according to a preferred embodiment of the present invention includes a density modulation step of executing a first mode in which an operation of outputting as many input signals as a first predetermined number and an operation of blocking as many input signals as a second predetermined number are repeated, or a second mode in which an operation of outputting the input signals for a first interval and an operation of blocking the input signals for a second interval are repeated.

More specifically, the first mode is characterized in that as many input signals as the first predetermined number and as the second predetermined number are counted, and in that as many input signals as the first predetermined number are output and as many input signals as the second predetermined number are blocked. Further, the second mode is characterized in that input signals are filtered and output using a filter signal in which a high signal is output for the first interval and a low signal is output for the second interval.

In addition, the piezoelectric actuator driving method according to a preferred embodiment of the present invention is characterized by further including one or more of a frequency modulation step of modulating the frequency of each input signal and outputting a modulated signal, a duty ratio modulation step of modulating the duty ratio of the input signal and outputting a modulated signal, and an amplitude modulation step of modulating the amplitude of the input signal using a constant envelope waveform and outputting a modulated signal.

The frequency modulation step is preferably configured to set the modulation frequency while gradually changing the modulation frequency from a preset maximum frequency to a preset minimum frequency or from the minimum frequency to the maximum frequency, and to modulate the frequency of the input signal depending on the set modulation frequency.

Further, the duty ratio modulation step is preferably configured to set the duty ratio while gradually changing the duty ratio from a preset maximum duty ratio to a preset minimum duty ratio or from the minimum duty ratio to the maximum duty ratio, and to modulate the duty ratio of the input signal depending on the set duty ratio.

Furthermore, the amplitude modulation step is preferably configured to generate a constant envelope waveform and modulate the amplitude of the input signal depending on the generated envelope waveform.

In accordance with experiments based on the device and method for driving a piezoelectric actuator according to the present invention, remarkable noise reduction results were obtained when a pulse density modulation method is combined with an amplitude modulation method or a pulse duty ratio modulation method, compared to driving based on the amplitude modulation method or the pulse duty ratio modulation method alone.

In detail, when the piezoelectric actuator is driven using an amplitude modulation method alone, it was proven that noise of about 7 dB was produced in an anechoic room. However, when the piezoelectric actuator is driven by combining the amplitude modulation method with the pulse density modulation method, it was proven that noise of 0.1 dB was produced. Similarly, when the piezoelectric actuator is driven by combining the pulse duty ratio modulation method with the pulse density modulation method, it was proven that noise of about 2 dB was produced.

Therefore, it can be seen that, in order to effectively reduce noise upon driving a motor using a piezoelectric element, remarkable effects can be achieved by combining the amplitude modulation method, the pulse duty ratio modulation method or the frequency modulation method with the pulse density modulation method and by utilizing a combined method.

Therefore, it can be seen that the device and method for driving a piezoelectric actuator according to the present invention can be efficiently used to realize the auto-focus (AF) function of a camera.

In accordance with the device and method for driving a piezoelectric actuator according to preferred embodiments of the present invention, noise occurring when a piezoelectric actuator required for the auto-focus function of a camera is driven can be reduced, and thus the present invention can be widely used in the fields of cameras, such as cameras for mobile phones or the like.

What is claimed is:

1. A device for driving a piezoelectric actuator, comprising:
a signal generation unit for generating a signal having a certain frequency; and
a modulation unit for modulating and outputting the signal generated by the signal generation unit,
wherein the modulation unit comprises a density modulation unit for executing a first mode in which an operation of outputting as many input signals as a first predetermined number and an operation of blocking as many input signals as a second predetermined number are repeated, or a second mode in which an operation of outputting input signals for a first interval and an operation of blocking the input signals for a second interval are repeated.

2. The device of claim 1, wherein the first mode is configured to count as many input signals of the density modulation unit as the first predetermined number and as the second predetermined number, output as many input signals as the first predetermined number, and block as many input signals as the second predetermined number.

3. The device of claim 1, wherein the second mode is configured to filter and output the input signals of the density modulation unit using a filter signal in which a high signal is output for the first interval and a low signal is output for the second interval.

4. The device of claim 1, wherein the modulation unit further comprises one or more of:
a frequency modulation unit for modulating a frequency of each input signal and outputting a modulated signal;
a duty ratio modulation unit for modulating a duty ratio of the input signal and outputting a modulated signal; and
an amplitude modulation unit for modulating an amplitude of the input signal using a constant envelope waveform and outputting a modulated signal.

5. The device of claim 4, wherein the frequency modulation unit comprises:
a frequency setting module for setting a modulation frequency; and
a frequency modulation module for modulating the frequency of the input signal of the frequency modulation unit depending on the modulation frequency and outputting the modulated signal.

6. The device of claim 5, wherein the frequency setting module is configured to set the modulation frequency while gradually changing the modulation frequency from a preset maximum frequency to a preset minimum frequency or from the minimum frequency to the maximum frequency.

7. The device of claim 4, wherein the duty ratio modulation unit comprises:
a duty ratio setting module for setting a duty ratio; and
a duty ratio modulation module for modulating the duty ratio of the input signal of the duty ratio modulation unit depending on the duty ratio set by the duty ratio setting module, and outputting the modulated signal.

8. The device of claim 7, wherein the duty ratio setting module is configured to set the duty ratio while gradually changing the duty ratio from a preset maximum duty ratio to a preset minimum duty ratio or from the minimum duty ratio to the maximum duty ratio.

9. The device of claim 4, wherein the amplitude modulation unit comprises:
an envelope generation module for generating a constant envelope waveform; and
an amplitude modulation module for modulating the amplitude of the input signal of the amplitude modulation unit depending on the envelope waveform generated by the envelope generation module, and outputting the modulated signal.

10. The device of claim 9, wherein the amplitude modulation module modulates the amplitude of the input signal of the amplitude modulation unit by mixing the input signal of the amplitude modulation unit with the envelope waveform.

11. A method for driving a piezoelectric actuator, comprising:
executing a first mode in which an operation of outputting as many input signals as a first predetermined number and an operation of blocking as many input signals as a second predetermined number are repeated, or a second mode in which an operation of outputting input signals for a first interval and an operation of blocking the input signals for a second interval are repeated.

12. The method of claim 11, wherein the first mode is configured to count as many input signals as the first predetermined number and as the second predetermined number, output as many input signals as the first predetermined number, and block as many input signals as the second predetermined number.

13. The method of claim 11, wherein the second mode is configured to filter and output the input signals using a filter signal in which a high signal is output for the first interval and a low signal is output for the second interval.

14. The method of claim 11, further comprising one or more of:
modulating a frequency of each input signal and outputting a modulated signal;
modulating a duty ratio of the input signal and outputting a modulated signal; and
modulating an amplitude of the input signal using a constant envelope waveform and outputting a modulated signal.

15. The method of claim 14, wherein modulating the frequency is configured to set the modulation frequency while gradually changing the modulation frequency from a preset maximum frequency to a preset minimum frequency or from the minimum frequency to the maximum frequency, and to modulate the frequency of the input signal depending on the set modulation frequency.

16. The method of claim 14, wherein modulating the duty ratio is configured to set the duty ratio while gradually changing the duty ratio from a preset maximum duty ratio to a preset minimum duty ratio or from the minimum duty ratio to the maximum duty ratio, and to modulate the duty ratio of the input signal depending on the set duty ratio.

17. The method of claim 14, wherein modulating the amplitude is configured to generate a constant envelope waveform and to modulate the amplitude of the input signal depending on the generated envelope waveform.
